(19) United States
(12) Patent Application Publication
(10) Pub. No.: US 2026/0222486 A1
(43) Pub. Date: Jul. 30, 2026

(54) Real-Time Fraud and AI Voice Detection and Warning

(71) Applicant: Hiya, Inc., Seattle, WA (US)

(72) Inventors: James Kai Yu Lau, Kirkland, WA (US); Christopher Lee Thomas, Seattle, WA (US); Ryan Kazda, Bothell, WA (US); Anthony Mendonca, Seattle, WA (US); Brent Newman, Seattle, WA (US); Chaitanya Krishna Medipally, Seattle, WA (US); Kirti Chandak, Bellevue, WA (US); Matthew Austin Hertogs, Seattle, WA (US); Ryan Michael Adams, Varshon, WA (US); Wilson Bull, Seattle, WA (US); Tyler Marklyn, Seattle, WA (US); Stephen Orth, Seattle, WA (US); Shahzadah Babu, London (GB); Katelynn Oleson, Seattle, WA (US); David Kay, Seattle, WA (US)

(21) Appl. No.: 19/462,754

(22) Filed: Jan. 28, 2026

Related U.S. Application Data
(60) Provisional application No. 63/750,575, filed on Jan. 28, 2025.

(51) Int. Cl. H04M 3/22; H04M 3/527

(52) U.S. Cl. CPC H04M 3/2281; H04M 3/527

(57) ABSTRACT

Systems and methods are disclosed for performing real‑time fraud detection during an in‑progress call between a calling device and a called device over a telephone network. Call audio is monitored and evaluated by a filtering model that generates an indication of fraud. When the filtering model output indicates potential fraud, data describing the calling device and the call content are provided to a fraud detection machine learning model. The model generates a fraud detection value indicating a likelihood that the call is fraudulent. If the value exceeds a threshold, the called device presents a fraud alert.

### CROSS-REFERENCE TO RELATED APPLICATION

This application claims priority to U.S. Provisional Application No. 63/750,575, filed Jan. 28, 2025, which is incorporated by reference.

### BACKGROUND

### 1. Field of Art

The subject matter described relates generally to the field of telephony and specifically to monitoring audio channels associated with in-progress calls to perform real-time fraud and AI voice detection.

### 2. Background Information

Nuisance telephone calls are a growing problem. Such calls include unsolicited calls from callers like telemarketers and fraudsters. Computer technology, such as “robocallers,” allows nuisance callers to place high volumes of calls. Moreover, centralized directory services make it easier for nuisance callers to gather large amounts of telephone numbers. The combination of these two abilities allows nuisance callers to engage in mass calling campaigns. These unwanted calls interrupt and annoy the called party and may also lead to fraud.

In addition, technical characteristics of the telephone network make it relatively easy for a caller to spoof the telephone number from which a call is reportedly placed. Some callers take advantage of this ability for legitimate purposes. For example, a call center run by a legitimate party in which multiple different people make outbound calls may spoof the calling telephone number so that all of its calls appear to originate from a single number. Malicious callers also take advantage of the ability to spoof calling numbers. For example, a fraudulent caller can spoof the number of a legitimate caller or use artificial intelligence (AI) to impersonate someone else (e.g., someone known to the called party) so that the call appears legitimate. The caller may then defraud the called party by impersonating the legitimate caller.

### SUMMARY

The above and other issues may be addressed by a method, computer system, and computer-readable storage medium for performing real-time detection and warning of AI voices or fraudulent calls by monitoring in-progress calls and performing dynamic, context-aware security functions in real time.

In one embodiment, the method includes receiving audio signals or transcribed text from an in-progress call between a calling device and a called device. The method also includes generating, by a filtering model, an initial indication of whether the call presents a risk of fraud based on one or more factors such as caller identity, relationship between the number associated with the calling device and the called party, keywork matches, and tonal patterns. If the filtering stage indicates potential fraud, the method invokes a fraud detection machine learning model to produce a fraud likelihood value using additional features such as a semantic analysis of the conversation, caller data, and historical call records. Responsive to the fraud likelihood value exceeding a threshold, the called device issues a fraud alert using one or more modalities, such as on-screen messages, audio notifications, or haptic feedback.

In some embodiments, the system further incorporates real-time AI voice detection models trained to identify synthetic or computer-generated speech during live calls, issuing alerts when such speech is detected. Reputation indicators obtained from carrier-level analytics platforms can be incorporated into the screening process, allowing the system to automatically and dynamically adjust its screening strictness and provide adaptive fraud prevention in response to changes in a caller’s perceived trustworthiness. The disclosed techniques may also be applied to contexts involving autonomous or semi-autonomous call assistants, enabling real-time transcript monitoring, seamless user takeover of screened calls, and conversational voicemail summarization with suggested actions.

### BRIEF DESCRIPTION OF DRAWINGS

FIG. 1 is a block diagram illustrating a computing environment for secure call monitoring and analysis, according to one embodiment.

FIG. 2 is a block diagram illustrating a detailed view of the caller verification and monitoring server of FIG. 1, according to one embodiment.

FIG. 3 is a block diagram illustrating a detailed view of the processing module of a called device of FIG. 1, according to one embodiment.

FIG. 4 is a flowchart illustrating a method for verifying a communication, according to one embodiment.

FIG. 5 is a flowchart illustrating a method for performing real-time fraud detection and warning, according to one embodiment.

FIG. 6 is a block diagram illustrating an example of a computer for use as one of the entities shown in FIG. 1, according to one embodiment.

### DETAILED DESCRIPTION

The Figures(FIGS.) and the following description describe certain embodiments by way of illustration only. One skilled in the art will readily recognize from the following description that alternative embodiments of the structures and methods described may be employed without departing from the principles described. Reference will now be made to several embodiments, examples of which are illustrated in the accompanying figures. It is noted that wherever practicable similar or like reference numbers may be used in the figures and may indicate similar or like functionality.

### Example Systems

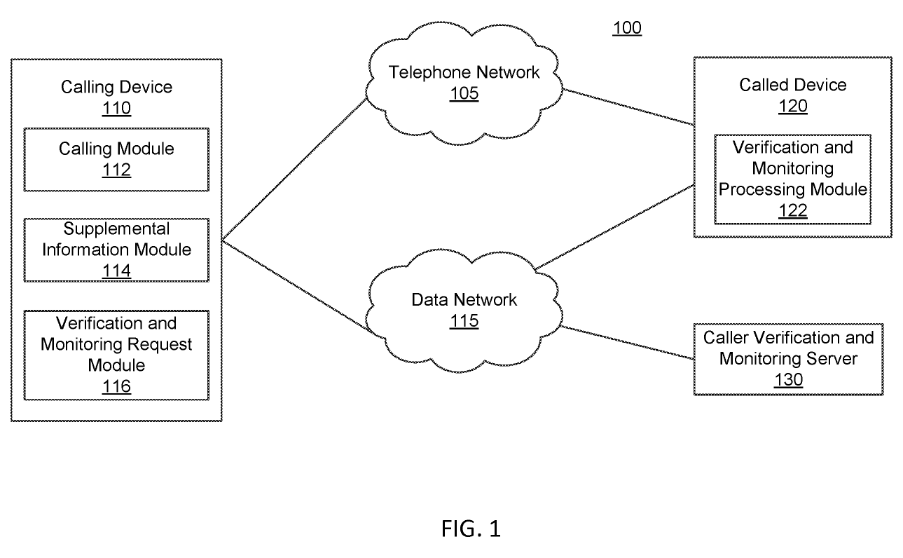

FIG. 1 illustrates one embodiment of a computing environment 100 for secure call monitoring and analysis, including one or more of caller verification, real-time fraud detection, AI voice detection, or adaptive screening. As shown, the computing environment 100 includes a calling device 110, a called device 120, and a caller verification and monitoring server 130, which are connected via a telephone network 105 and a data network 115. Only one calling device 110, called device 120, and caller verification and monitoring server 130 are illustrated in FIG. 1 for clarity. Embodiments of the computing environment 100 may include and support multiple concurrent calling devices 110, called devices 120, and monitoring servers 130 deployed in different locations or configurations. Likewise, the entities can be arranged and the functionality distributed between entities in different manners than described.

The telephone network 105 enables electronic communication between the calling device 110 and the called device 120. As used herein, the term telephone network refers to the channels used to send communications (e.g., audio data or text messages) from one device to another device, such as conventional telephone networks, voice over internet protocol (VOIP) calls, satellite connections, software communication applications (e.g., WHATSAPP®), and any other suitable connection for routing communications from a calling device 110 to a called device 120. In one embodiment, the telephone network 105 routes a communication, such as a telephone call or text message, from the calling device 110 to the called device 120. The telephone network 105 routes the communication using a called number provided by the calling device 110. In addition, the telephone network 105 identifies the calling device 110 using a calling number. In cases where the calling number is being spoofed, the calling number may not be connectable to the calling device 110 and may in fact identify a different device. The telephone network 105 may provide the calling number to the called device 120 in association with the communication. In addition, the telephone network 105 may provide additional information, such as a 15-character string describing the communication, via the Caller ID Name (CNAM) service.

In one embodiment, the telephone network 105 uses standard communication technologies or protocols. For example, the telephone network 105 may be the public switched telephone network (PSTN). The network protocols used on the telephone network 105 can include Common Channel Signaling System 7 (CCSS7), SIGTRAN, the Session Initiation Protocol (SIP), etc. The telephone network 105 may also include cellular or other forms of networks supporting mobile telephones using attendant protocols, such as the Long Term Evolution (LTE) protocol.

The data network 115 enables electronic communication between the calling device 110, called device 120, and caller verification and monitoring server 130 and can carry metadata, verification messages, fraud alerts, AI-voice detection notifications, audio streams, or text transcriptions used for real-time analysis. In one embodiment, the data network 115 is the Internet. The data network 115 supports standard Internet communications protocols such as the Transmission Control Protocol/Internet Protocol (TCP/IP). The data network 115 and telephone network 105 may share communication paths. However, the data network 115 is logically separate from the telephone network 105 and may use different communication paths and protocols. A message sent over the data network 115 is said to be “out-of-band” relative to the telephone network 105 because the message is travelling over a logically-separate network. In one embodiment, the telephone network 105 and the data network 115 operate at approximately the same speed. That is, a communication placed over the telephone network 105 and a communication placed over the data network 115 both take approximately the same amount of time to transit from the source to the destination.

The calling device 110 is a telephone or another electronic device with telephone-like functionality that allows one or more human or artificial intelligence (AI) callers to place calls. For example, the calling device 110 can be an individual landline or mobile telephone used by a single caller to place calls. The calling device 110 can also be computer operating call platform software or an AI calling agent that allows multiple people or automated systems to place calls simultaneously, such as software operated by a telemarketer. The calling device 110 from which a call is placed has an associated calling number. The calling number may be fixed, so that all calls from the calling device 110 have the same calling number. The calling number may be dynamic, so that different calls from the calling device 110 have different calling numbers. For example, calls from a call center may originate from a same calling number associated with the telemarketer. In some embodiments, dynamic calling numbers and AI-generated voice content may trigger additional fraud screening by the monitoring server 130, as discussed below. A call originating from the calling device 110 also has an associated called number. The called number identifies the party to whom the call is placed.

As shown in FIG. 1, the calling device 110 includes a calling module 112, a supplemental information module 114, and a verification and monitoring request module 116. Some embodiments have additional or different modules, including modules for initiating AI-assisted calls or generating live audio/transcription feeds for monitoring. The functions ascribed to the modules may be distributed among the modules in a different manner than described and may be integrated with fraud detection and AI voice analysis subsystems.

The calling module 112 places communications to the called device 120 via the telephone network 105. For example, the calling module 112 may place a telephone call to the called device 120 initiated by a human user or AI calling agent. The calling module 112 specifies the called device 120 using a called number. In addition, the calling module 112 identifies the calling device 110 using a calling number, with dynamic caller ID contexts triggering additional fraud/voice analysis in some embodiments. The calling module 112 can associate different calling numbers with different placed communications and may also transmit initial metadata or risk signals to the monitoring server 130, enabling adaptive screening during call setup. The calling module 112 may place communications on-demand or on a schedule, including as part of an AI-assisted workflow or automated outbound notification system.

The supplemental information module 114 associates supplemental information with communications placed by the calling module 112. In one embodiment, the supplemental information includes information about the calling device 110 (which may be spoofed) and information about a communication placed by the calling device via the telephone network 105. The supplemental information may further include one or more of real-time risk assessment data, caller reputation indicators (e.g., metrics or scores) from analytics platforms, or indicators of prior fraud detection models. The supplemental information may also include one or more of the name, address, image, business hours, or contact information for the calling device 110. The contact information for the calling device 110 may include the physical or Internet addresses of the calling device, one or more contact telephone numbers different than the calling number, etc. The supplemental information about a communication may include the date/time that a communication was, or will be, placed, estimated duration of the communication, type of the communication (e.g., a telephone call or a text message), calling and called numbers for the communication, and the purpose of the communication. The date/time that the communication was or will be placed can be specified within a range of dates or times. In embodiments including AI voice detection functionality, supplemental information may also include a pre-call AI voice authenticity value derived from historical speech samples for the caller. The supplemental information may further include information about the called device 120 or a user of the called device 120 or a message for the user of the called device 120.

The supplemental information module 114 generates the supplemental information or retrieves the information from a database or another source. For example, the supplemental information module 114 may communicate with the calling module 112 to detect when a communication has been or will be placed and obtain supplemental information particular to the communication, such as the time/date of the communication, the calling number, and the called number. The supplemental information module 114 may access a database to obtain information describing the purpose of the communication and describing the called device 120.

The verification and monitoring request module 116 sends verification and monitoring request messages to the caller verification and monitoring server 130 via the data network 115. In one embodiment, a request message requests that the caller verification and monitoring server 130 verify to the called device 120 that a communication placed by the calling device 110 is legitimate (i.e., was in fact placed by the calling device to the called device) and analyze the communication for indicators of fraud or AI voice synthesis. For example, a request message may include supplemental inputs or metadata for fraud and AI voice detection, such as segments of live call audio, text transcriptions of the conversation, caller reputation indicators, or screen parameters. In some embodiments, the verification request message is sent out-of-band from the communication made by the calling module 112 because the request message travels over the data network 115 rather than the telephone network 105.

The verification and monitoring request module 116 interacts with the calling module 112 and supplemental information modules 114 to identify placed communications and associated supplemental information. The request module 116 sends a request message for each, or a subset, of the communications placed by the calling module 112. In one embodiment, the request module 116 sends a request message for a particular communication contemporaneously with when the calling module 112 places the communication. The request module 116 thus sends request messages on an ongoing basis, as communications are placed by the calling module 112. The request module 116 may also send request messages before the calling module 112 places the communications. For example, the request module 116 may send a request message that identifies multiple communications that will be placed by the calling module 112 in the future, along with associated supplemental information.

The caller verification and monitoring server 130 notifies called devices 120 of verification results and, in some embodiments, real-time monitoring analyses or whether communications received by the devices are from verified calling numbers. In some embodiments, the server 130 further notifies called devices 120 whether received communications exhibit indicators of fraud, spam, or AI-generated voice content. The server 130 receives verification and monitoring request messages from a calling device 110 via the data network 115. The caller verification server 130 obtains the supplemental information from the messages along with, in some embodiments, real-time call content, transcriptions, caller reputation indicators, or AI voice detection metadata and uses these inputs to identify communications placed, or that will be placed, by the calling device 110 to called devices 120. The server 130 communicates with called devices 120 via the data network 115 to verify to the called devices 120 that communications received by the devices are legitimate and to provide alert outputs when fraud or AI voice is detected. That is, the server 130 uses the supplemental information and monitoring results to verify to a called device 120 that a communication received by the called device 120 via the telephone network 105 is legitimate (i.e., that the communication was placed by the calling device 110 that purports to have placed the communication) and to notify the called device 120 of elevated risk based on fraud detection scoring or synthetic voice classification, as discussed below. The caller verification server 130 may also provide some or all of the supplemental information and monitoring analysis and results to the called device 120.

The called device 120 is a telephone or other electronic device with telephone-like functionality that allows a called party to receive a call or other communication placed by the calling device 110. The called device 120 can be an individual landline or mobile telephone. The called device 120 can also be a computer executing software that allows the computer to receive communications via the telephone network 105. The called device 120 has an associated called number. Communications sent to the associated called number via the telephone network 105 are received by the called device 120. Although this description refers to the device as the “called device” 120, the device may also have functionality allowing it to place communications to other devices. In addition, the called device 120 is in communication with the data network 115, e.g., for receiving verification results, fraud/AI voice detection alerts, adaptive screening instructions, and real-time call monitoring data.

The called device 120 includes a verification and monitoring processing module 122 which verifies that communications received by the called device 120 are legitimate and processes monitoring and analysis outputs, such as fraud likelihood values, AI voice detection results, and recommended actions. The processing module 122 may be an application executing on the called device 120. Alternatively, the processing module 122 may be part of an operating system executing on the called device 120. In either case, the processing module 122 may interact with remote services or devices to provide the described functionality. In one embodiment, the processing module 122 detects when a communication, such as a call, is received by the called device 120 via the telephone network 105. The processing module 122 communicates with the caller verification and monitoring server 130 via the data network 115 to determine whether the received communication is legitimate and includes indicators of fraud or synthetic voice content. For example, the processing module 122 may determine the calling number associated with a received communication and query the server 130 to determine whether the communication is legitimate (i.e., the communication is really from the calling device associated with the calling number), suspicious, or fraudulent. In another example, the processing module 122 may receive a message from the server 130 via the data network 115 contemporaneously with when the communication is received via the telephone network 105 and use the message to verify legitimacy or present risk alerts. The processing module 122 reports the result of the verification and monitoring analysis, i.e., whether the communication is legitimate, to the user of the called device 120, using one or more of visual, audio, and haptic feedback, e.g., depending on alert severity.

The computing environment 100 described above thus provides security on the telephone network 105 by allowing users of called devices 120 to discriminate between calls that are verified as legitimate and other types of calls, such as calls that are flagged as potentially fraudulent or identified as containing synthetic (e.g., AI-generated) voice content. A call from a malicious caller who is using technical characteristics of the telephone network 105 to spoof a legitimate calling number for a communication will fail verification and may trigger a fraud or AI voice detection alert. A user can use the verification or monitoring results, or lack thereof, as guidance as to whether to respond to a communication (e.g., answer a call) or to guide the sort of information that the user discloses as part of a communication. For example, a user may choose to disclose confidential information in response to a verified and low-risk communication and withhold such information in response to non-verified or high-risk communications flagged by the server 130. Accordingly, the computing environment 100 overcomes the technical security weakness in the telephone network 105 that allows calling devices 110 to spoof calling numbers and mitigates risks associated with real-time fraud attempts and AI-driven voice impersonation.

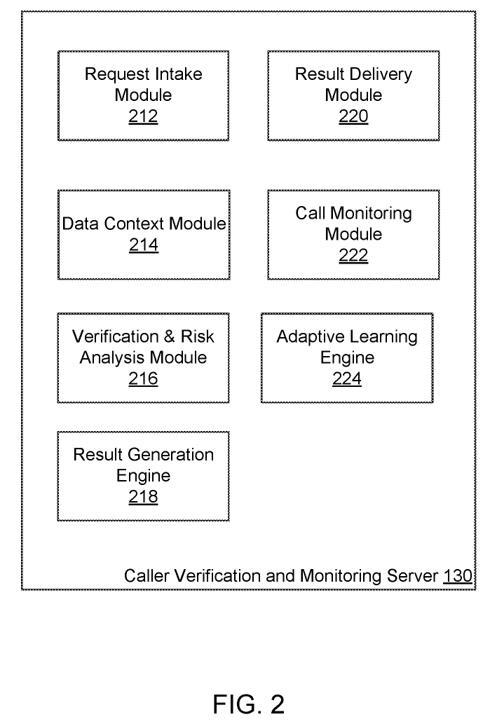

FIG. 2 is a block diagram illustrating a detailed view of one embodiment of the caller verification server 130. As shown in FIG. 2, the caller verification server 130 includes multiple modules, including a request intake module 212, a data context module 214, a verification and risk analysis module 216, a result generation engine 218, a result delivery module 220, a call monitoring module 222, and an adaptive learning engine 224. In some embodiments, the functions are distributed among the modules in a different manner than described. Moreover, the functions may be performed by other entities or distributed differently between entities in some embodiments.

The request intake module 212 receives verification and monitoring request messages and real-time data streams from calling devices 110 via the data network 115. In one embodiment, the request intake module 212 provides a secure application program interface (API) or other authenticated communication channel and receives requests, data payloads, and streaming inputs from only authorized and identified calling devices 110 or third-party analytics services.

The request intake module 212 is configured to parse incoming messages to obtain supplemental information (e.g., calling/called numbers, purpose of call, caller identity, etc.) and additional monitoring inputs such as live audio segments, speech-to-text transcripts, caller reputation indicators, previous call history, and AI-voice detection metadata. In some embodiments, the request intake module 212 supports batch-mode ingestion of pre-scheduled communications and real-time ingestion for in-progress calls. The request intake module 212 may further normalize and validate inputs, ensuring that audio or text streams meet the expected format, that metadata aligns with predefined schemas, and that caller identity data is cross-checked against secure registries. Any anomalous or incomplete requests can be flagged and optionally forwarded to the adaptive learning engine 224 for use in model training. Still further, in some embodiments, the request intake module 212 conducts an initial filtering operation before forwarding data to other modules of the caller verification and monitoring server 130, such as by detecting the presence of high-risk keywords or number patterns in the metadata, applying lookup operations to determine whether identifying information provided by the calling device 110 (such as a phone number or other metadata) matches entries in a known block list or a database of spam or fraudulent call sources. This initial filtering followed by more detailed analysis can optimize the use of computational resources by preventing calls from being further scrutinized once they have been determined to be low risk.

The data context module 214 enhances, structures, and contextualizes the supplemental information (e.g., names, numbers, basic call details) and monitoring inputs received in verification and monitoring request messages. In one embodiment, the data context module 214 retrieves additional information from internal databases, external network sources, and reputation scoring services to build a more complete context around each communication. The data context module 214 merges the supplemental and additional information into an expanded dataset for use in verification, fraud likelihood scoring, and AI voice detection operations, as described below.

In some embodiments, the data context module 214 normalizes and validates incoming data to provide consistency across disparate sources. For example, in various implementations, the data context module 214 reconciles numerical formats, verifies timestamps against event logs, and cross-checks caller identities with trusted registries or watchlists. The data context module 214 may further assign contextual metadata, such as source confidence values, data freshness timestamps, and relevancy tags and perform relationship mapping by linking the calling number to historical communication patterns, known organizational affiliations, or mutual contexts with the called device 120. In still other embodiments, the data context module 214 enriches received data with behavioral context for the calling number, such as detecting that the calling device 110 is attempting to contact the called device 120 outside typical time windows or identifying anomalies such as mismatched geolocation signals.

The verification and risk analysis module 216 receives (e.g., from the data context module 214) an enriched and validated dataset and analyzes the received data to determine the legitimacy of a communication and assess its risk level for fraud, spam, or AI-generated voice content. As described above, in some embodiments, the supplemental information includes information about calling parties and information about communications placed by the calling number on the telephone network 105, dynamic inputs such as caller reputation indicators, prior call history, relationship indicators between parties, filtering results from the request intake module 212, and the like.

For a given verification or monitoring request, the verification and risk analysis module 216 identifies the calling number and the called device 120 and correlates these identifiers with known trusted, suspicious, or block-listed sources. Additionally, the verification and risk analysis module 216 identifies the associated communication on the telephone network 105 and when the communication has been or will be placed. The verification and risk analysis module 216 further ingests real-time data streams from in-progress calls, such as audio segments captured from the voice channel, text transcriptions generated through automatic speech recognition (ASR) systems, and the like. The verification and risk analysis module 216 analyzes the received data against one or more detection layers, such as by performing keyword and phrase matching using lexicons associated with fraudulent solicitations, spam behavior, or AI voice prompts; semantic pattern analysis using large language models or NLP pipelines to identify conversational intent and flag unusual or inconsistent responses; tone marker evaluation to measure vocal characteristics such as urgency, pitch variability, stress patterns, and pauses that may correlate with fraudulent or coercive intent; and AI voice likelihood modeling using synthetic voice classifiers to identify acoustic features indicative of computer-generated speech.

Where multiple detection layers are used, the verification and risk analysis module 216 may combine the outputs from the evaluation layers within a weighted scoring framework to generate a composite risk value for the call reflecting a likelihood that the call is fraudulent, spam, or includes synthetic (AI-generated) voice content. In some embodiments, weighting values are dynamically tuned based on one or more of historical model performance, current spam/fraud trends, and contextual factors such as the caller’s reputation, call history between the parties, and the like.

The composite risk value and verification determination are transmitted to the result generation engine 218, which generates an associated output, such as a “verified” message, a fraud warning, an AI-voice alert, or suggested user action such as terminating the call, initiating a call-back, or sending a template SMS. In one embodiment, if the composite value falls within a defined intermediate range (e.g., where the call is “borderline”), the verification and risk analysis module 216 triggers an adaptive screening protocol, instructing the call monitoring module 222 to adjust monitoring thresholds to increase sensitivity, such as by lowering fraud detection thresholds, expanding keyword monitoring, and prolonging semantic analysis, before determining whether to recommend that the user engage with the communication.

The result generation engine 218 receives verification determinations and risk analysis outputs from the verification and risk analysis module 216 and generates result output for delivery to the called device 120. The engine 218 generates the output by selecting elements from the enriched dataset and the risk scoring output from the verification and risk analysis module 216. Depending on the determination, the output may contain one or more of: a verification status (e.g., “Verified Caller,” “Not Verified,” “Suspicious Caller,”), risk indicators such as a numeric composite value or a tiered risk level (low/medium/high), fraud detection results (e.g., highlighting keywords or factors that triggered the alert), AI-voice detection results with likelihood values and context indicators, and one or more suggested actions, such as “Terminate call,” “Call back,” or “Send SMS reply.” In some embodiments, the output further includes descriptive content associated with the call or the calling number, such as a caller name, purpose of the call, logos, images, or business hours for legitimate callers.

The result generation engine 218 applies formatting rules such that result output is structed for multimodal presentation on the called device’s UI, audio channel, and/or haptic output systems. In some embodiments, the engine 218 generates layered messages, such as a concise high-urgency alert followed by a detailed expanded view accessible by the user of the called device 120. Still further, in adaptive screening contexts, the results generation engine 218 tags the result with routing instructions for the call monitoring module 222, enabling escalated, real-time monitoring before final recommendation to the user. The engine 218 also logs the structured result output, e.g., for analytics, reporting, and training of the adaptive learning engine 224.

In various embodiments, the result delivery module 220 transmits the result output to the called device 120 using push or pull-based techniques. In an embodiment using a push technique, the result delivery module 220 actively monitors the scheduling and placement of communications based on data received from the request intake module 212 and data context module 214. When a call is imminent or in progress, the result delivery module 220 pushes the relevant result output to the called device 120 before or contemporaneously with the call to ensure that the user of the called device 120 receives legitimacy status or risk alerts in time to influence the user’s decision to answer or terminate the call.

In an embodiment using a pull technique, the result delivery module 220 responds to secure API requests from called devices 120. The request may identify the incoming caller and include metadata such as the calling number or CNAM string. The result delivery module 220 queries a database (not shown) on the caller verification and monitoring server 130 to identify verification results and analysis matching the request and sends the identified result output to the requesting device. Outputs provided via push or pull-based techniques may be formatted for multimodal delivery to the called device 120, enabling the device to deliver alerts visually through UI banners, audibly via tones or spoken messages, and physically through haptic feedback (e.g., unique vibration patterns for high-risk calls). The result delivery module 220 may further tag each result with severity information to enable the called device 120 to adapt the intensity of notifications based on risk level. Delivered results (including timestamps, delivery methods, and acknowledgement status) may further be logged in an activity records and, in some embodiments, are used to train the adaptive learning engine 224 with data on which alerts were delivered, viewed, or acted upon.

The call monitoring module 222 monitors the audio channel of in-progress communications between a calling device 110 and a called device 120 over the telephone network 105. In various embodiments, the call monitoring module 222 ingests raw audio data or text transcriptions generated through ASR and applies multi-layered analysis pipelines to detect potential fraud, spam, or synthetic (AI-generated) voice content.

At a first detection layer, the call monitoring module 222 executes a filtering model that evaluates indicators of fraud. For example, the filtering model performs keyword and phrase matching using lexicons of high-risk terms (e.g., “urgent legal action,” “remote access request”), assesses caller identity attributes, and considers relationship context (e.g., whether the calling number appears in the user’s contact list). Calls from a trusted source, such as a contact stored in the contact list of the called device 120, may pass the filtering step even if keywords suggestive of fraud are detected. Alternatively, a higher threshold for the number of words associated with fraud used or different groupings of words considered to be indicative of fraud may be used for contacts in the device’s phone book.

When a call is flagged by the filtering model, the call monitoring module 222 invokes one or more machine learning models, such as a large language model (LLM), to conduct semantic pattern analysis, tone and voice characteristic evaluation, and AI-voice likelihood detection. The semantic pattern analysis interprets the conversational flow and identifies deceptive or abnormal dialogue structures, such as sudden shifts in topic, repetitive solicitation language, or contextless requests for sensitive information. Tone and voice characteristic evaluation measures properties such as urgency cues, irregular pitch changes, abnormal pacing, prolonged pauses designed to prompt a response, and vocal stress markers indicative of coercion or scripted behavior.

In one embodiment, the call monitoring module 222 further performs real-time AI voice detection during an active communication between a calling device 110 and a called device 120. To do so, the call monitoring module 222 receives an audio stream from the in-progress call and may optionally generate text transcriptions using ASR. The call monitoring module 222 segments the audio stream into frames (e.g., one-second intervals) and extracts acoustic and spectral features that differentiate human speech from computer-generated speech, such as speech rate variability, fluctuations in pitch and amplitude, presence and timing of breath sounds and pauses, presence of non-verbal cues (e.g., coughs, sneezes, lip smacks, etc.), spectral complexity, frequency range, intonation and pitch contours, stress and emphasis, and the like. The feature vectors are fed into one or more machine learning classifiers trained to detect computer-generated speech. In some embodiments, the classifiers include convolutional neural networks (CNNs), recurrent neural networks (RNNs), transformer-based architectures, or generative adversarial network (GAN) discriminators. For each segment, the classifier outputs a likelihood value representing the probability that the analyzed voice is AI-generated. The call monitoring module 222 aggregates values for individual audio segments into an overall session-level value, e.g., using weighted averaging, where segments that exhibit stronger indicators of synthetic voice are weighted more heavily than segments with weaker AI-voice indicators. In some embodiments, the call monitoring module 222 compares the aggregated value to a detection threshold, which may be dynamically adjusted based on contextual factors including the caller’s reputation, historical interactions, fraud-risk assessment, and the like.

In some embodiments, output from the fraud content analysis and AI voice detection are merged within a composite risk scoring framework. The framework applies weighted scoring, where higher-confidence indicators (e.g., confirmed AI-voice usage or strong evidence of fraudulent conversational intent) are weighted more heavily. The resulting composite value represents the probability that the call is fraudulent, spam, or includes AI-generated speech. Responsive to the composite value exceeding a first, higher threshold, the result generation engine 218 generates an output including the verification status, risk indicators, AI voice detection results, and suggested user actions. The result delivery module 220 transmits the alert to the called device 120 in one or more formats, including visual banners, audio tones, and haptic feedback. Alternatively, the result generation engine 218 generates output containing distinct indicators for each detection layer, such as the fraud likelihood value or fraud tier risk (low/medium/high) generated by the fraud detection model, the AI-voice likelihood value from the voice classifier, and one or more additional metrics, such as the caller reputation value. The result delivery module 220 may format and deliver the values individually in the user interface of the called device 120.

Where the value does not exceed the first, higher threshold but exceeds a second, lower threshold, the call monitoring module 222 triggers an adaptive screening protocol, under which the call monitoring module 222 increases the depth and sensitivity of the monitoring to determine whether the call is fraudulent or AI-generated. For example, adjustments may include one or more of lowering keyword detection thresholds (e.g., such that a lower number of suspicious terms or phrases trigger further analysis), broadening the monitored lexicon to include a wider range of potential fraud or AI-voice indicators, extending content analysis duration to capture more of the ongoing conversation, increasing sensitivity to voice characteristics, continuously reevaluating real-time transcripts for semantic inconsistencies, pressure tactics, or other conversational anomalies. In some embodiments, the call monitoring module 222 further analyzes contextual inputs, such as caller reputation, historical interactions between the calling number and the called device 120, and whether similar calls were flagged or blocked in the past. This information may influence the sensitivity of the screening, for example, a borderline risk value from a low-reputation caller may lead to more frequent and intensive checks.

In some embodiments, the call monitoring module 222 invokes an AI assistant comprising an autonomous or semi-autonomous software agent that can answer, screen, and manage incoming communications on behalf of the called party. For example, a user may designate the AI assistant to act as a “secretary” that answers incoming calls and determines when the called party should answer a call or allow the AI assistant to take a message on the called party’s behalf. During screening, the assistant can query the calling device 110 to determine the nature and legitimacy of the communication. To do so, the AI assistant applies configurable screening parameters, which may be generated automatically based on context or provided manually by the user, to tailor the dialogue and decision-making. These parameters can instruct the AI assistant to ask clarifying questions, confirm details, or request specific responses of the calling device 110.

In one embodiment, the AI assistant is configured to be interruptible, allowing the called party to observe the ongoing interaction in real time via a displayed transcript or audio feed on the called device 120. If the called party determines that they wish to engage directly with the calling device 110, the user can select an interface element on the called device 120 to take over the call. Alternatively, if the user opts not to join the call, the assistant can continue screening or prompt the calling device 110 to leave a message, which the assistant summarizes and delivers to the called party in text or audio form. To do so, the call monitoring module 222 extracts data from the call screening, such as an identification of the calling device 110 (e.g., the calling number used by the calling device), a purpose of the call, a time and date of the call, the message left by the calling device 110, etc. and inputs the extracted data to a machine learning model (e.g., a LLM) that generates the message summary.

Additionally, in some embodiments, the assistant queries one or more integrated applications on the called device 120, such as a calendar, to propose relevant follow-up actions. For example, if the call is about scheduling a meeting, the assistant can review the called party’s calendar to determine availability and propose one or more available timeslots in the summary. The summary may include other follow-up actions based on the content of the call, such as placing a return call to the called device 110, sending an SMS reply, confirming an appointment, or accepting or declining a meeting. The suggestions may be tailored based on user preferences, past behavior, or integrated fraud or AI-voice detection results.

In various embodiments, the AI assistant uses a semi-autonomous or fully-autonomous assistant mode to screen incoming calls from unknown calling numbers. For example, in a fully autonomous assistant mode, the AI assistant screens an incoming call without any input from the called party user. In a semi-autonomous assistant mode, the called party user provides one or more screening parameters to guide the AI assistant in screening the call. For example, the called party user could prompt the AI assistant to ask the caller to “tell me more” or “ok, confirmed” (if the caller is calling to confirm an appointment). The screening parameters provided may depend on the context of the call and, in some embodiments, are generated by the AI assistant. Additionally or alternatively, the parameters include free-form prompts provided by the called party user.

The call monitoring module 222 further logs outputs generated during the real-time analysis, including fraud detection and AI-voice likelihood values, associated alerts, and detailed contextual data about the monitored communication, such as keyword matches, semantic analysis results, tone metrics, caller reputation values, relationship indicators, and any adaptive screening adjustments during the call. The logged information may be transmitted to the adaptive learning engine 224, which processes the received data to maintain a feedback loop to improve detection accuracy and screening performance over time.

The engine 224 aggregates and labels the data to create training datasets for the filtering models and fraud/AI-voice detection models. Contextual elements such as matched keywords, detected semantic patterns, tone metrics, caller reputation values, and historical relationship maps, are incorporated into the training examples, and fraud and AI-voice detection outcomes are paired with known results (confirmed fraud, confirmed legitimate calls) to refine model weights and adjust detection thresholds.

The adaptive learning engine 224 further updates and expands detection lexicons for keyword matching, semantic pattern recognition, and tone analysis. For example, newly observed scam phrases, conversation flows, or AI-voice synthesis artifacts can be added to the lexicons and distributed across the modules of the caller verification and monitoring server 130. In some embodiments, the engine 224 ingests threat intelligence feeds, honeypot-collected spam call data, and aggregated analytics from carrier-grade systems to detect emerging patterns. The retrained and updated models and lexicons may be deployed to modules of the server 130, ensuring that the system adapts in near-real time to evolving fraud tactics, spam campaigns, and AI-driven impersonation techniques.

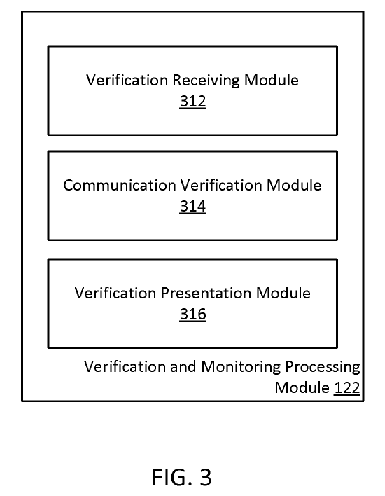

FIG. 3 is a block diagram illustrating a detailed view of one embodiment of the verification and monitoring processing module 122 of a called device 120. As shown in FIG. 3, the verification and monitoring processing module 122 includes multiple modules. In some embodiments, the functions are distributed among the modules in a different manner than described. Moreover, the functions are performed by other entities in some embodiments.

The verification receiving module 312 receives verification messages, risk evaluation results, and monitoring alerts from the caller verification and monitoring server 130 via the data network 115. Depending upon the embodiment, the verification receiving module 312 may receive these outputs pushed by the server 130, or the verification receiving module 312 may pull (i.e., request) outputs from the server 130 using a secure API. In the push embodiment, the verification receiving module 312 can receive verification messages, risk, and alert data from the caller verification server 130 at arbitrary times and forward the received data to other submodules of the verification and monitoring processing module 122.

In the pull embodiment, the verification receiving module 312 uses the API provided by the caller verification server 130 to request any verification messages or alerts applicable to the called device 120. The verification receiving module 312 may make the request when the called device 120 receives a communication via the telephone network 105 and include information about the received communication, such as the calling number or CNAM information, in the request. The verification receiving module 312 may also make the request at other times. The verification receiving module 312 receives one or more verification messages, or an indication that there are no verification messages, for the called device 120 in response to the request.

The communication verification module 314 attempts to confirm legitimacy and assess risk for communications received via the telephone network 105 using the verification messages and monitoring outputs received via the data network 115. The communication verification module 314 identifies information about a received communication, such as the calling and called numbers, CNAM data, and time/date received, and compares the data with the enriched supplemental information contained in the verification or monitoring output to identify matches, confidence levels, and discrepancies. For example, the communication verification module 314 can match the calling number of a received communication against the calling number in the associated verification message and then adjust match confidence based on contextual data such as recent caller value trends, relationship indicators between the calling number and called device 120, whether the number appears on a block list or contact list of the called device 120, etc.

The communication verification module 314 verifies a communication as legitimate if at least a threshold amount of data matches. In some embodiments, the threshold may be dynamically modified based on contextual factors, such as by lowering match requirements for known contacts or raising match requirements for high-risk indicators provided by external analytics services. For communications having composite risk values above a defined limit, the communication verification module 314 flags the call as suspicious even if partial data matches are present.

In one embodiment, if the called device 120 receives a verification message contemporaneously with the related communication via the telephone network 105, the communication verification module 314 verifies the communication if the calling number in the verification message matches the calling number of the incoming call and the risk assessment value is below a threshold. Conversely, if the called device 120 receives one or more verification messages before the calls are placed, the communication verification module 314 may verify the communication only if the calling number and the date/time that the communication will be placed match. The heightened scrutiny accounts for the increased window of opportunity for spoofing or fraud between the time the verification message is sent and the time the call is placed.

The verification presentation module 316 presents verification results, risk evaluations, and associated alerts to the user of the called device 120. In one embodiment, the verification presentation module 316 displays on the device’s user interface both the legitimacy status of a received communication and any associated risk indicators, such as fraud likelihood or AI-voice detection results. For example, the verification presentation module 316 may show a message indicating that the received communication is verified as legitimate (e.g., “VERIFIED CALLER”), flagged as suspicious, or confirmed fraudulent or AI-generated. The verification presentation module 316 may also provide the composite risk value or a tiered risk level (low/medium/high) in visually distinct formats, such as color-coded banners or icons.

The results can be presented using one or more modalities, such as visual indicators (display text, images, banners), audio cues (speech output, distinctive ringtones), and haptic feedback (vibration patterns). For example, a high-risk call may cause the called device 120 to vibrate strongly and display a red warning banner stating “LIKELY FRAUD – DO NOT ANSWER,” while a verified call might use a green banner with “VERIFIED CALLER” and supporting details.

The verification presentation module 316 may also present supplemental information and enhanced information from the associated verification or monitoring request message. For example, displayed information may include the calling number’s name, logo, purpose of the call, expected duration, or other contextual data provided by the data context module 214. If the output includes a suggested action (e.g., “Call Back,” “End Call,” “Send SMS”), the verification presentation module 316 can provide for display interactive controls enabling the user to take the suggested action from the presentation interface.

### Example Methods

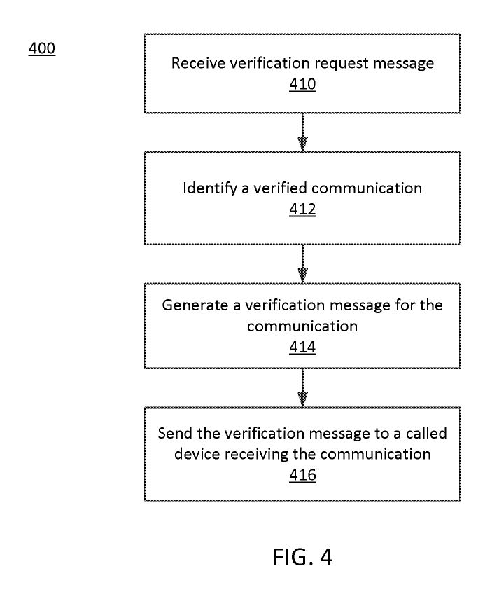

FIG. 4 is a flowchart illustrating a method for verifying a communiction, according to one embodiment. The method may be performed by the caller verification and monitoring server 130, although some or all of the operations in the method may be performed by other entities in other embodiments. In some embodiments, the operations in the flow chart are performed in a different order or can include different or additional steps.

In the embodiment shown, the method begins with the caller verification and monitoring server 130 receiving 410 a verification request message. The verification request message includes information about a calling number, the communication, and, optionally, a called device 120 that is a target of the communication. For example, the information included in the request may include one or more of segments of live call audio, text transcriptions of the conversation, caller reputation indicators, or screen parameters, etc. The verification and monitoring server 130 applies one or more models (as described previously) to determine that the communication is not fraudulent or otherwise illegitimate, thus identifying 412 the communication as verified. Assuming the caller verification and monitoring server 130 can verify the communication, it generates 414 a verification message and sends 416 the verification message to the called device 120 receiving the communication. Thus, the calling device 110 can proactively verify legitimate communications, giving the user of the called device 120 confidence that the communication is not fraudulent. In some embodiments, the verification message us sent 416 out-of-band, meaning it is sent via a route other than through the telephone network 105 (e.g., through the data network 115).

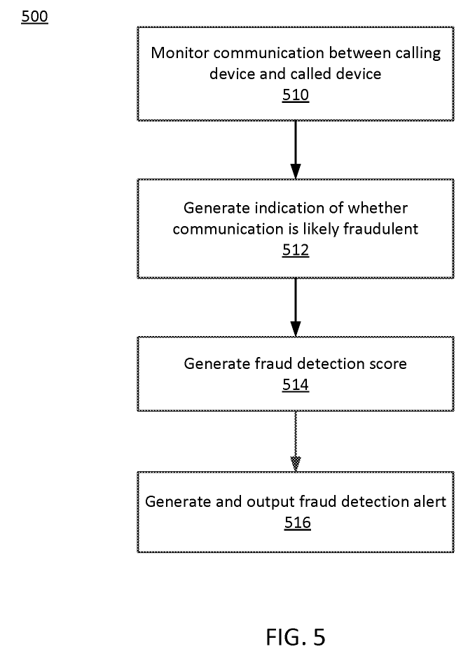

FIG. 5 is a flowchart illustrating a method for performing real-time fraud detection and warning, according to one embodiment. The method may be performed by the caller verification and monitoring server 130, although some or all of the operations in the method may be performed by other entities in other embodiments. In some embodiments, the operations in the flow chart are performed in a different order or can include different or additional steps.

In the embodiment shown, the method begins with the call monitoring module 222 of the caller verification server 130 monitoring 510 an audio channel of an in-progress communication from a calling device 110 to a called device 120 made via the telephone network 105. The call monitoring module 222 provides an audio stream of the communication or a text transcription (or both) to a filtering model, which performs a filtering step by generating 520 an indication of whether the communication is likely fraudulent. In one embodiment, the output indication is based on one or both of the calling number and the presence or absence in the audio stream or text transcription of keywords indicative of fraud. Moreover, the filtering model output may be, in some embodiments, a binary yes/no indication of likely fraud where a “yes” output causes the call monitoring module 222 to call a fraud detection machine learning model to generate a fraud detection value and a “no” output means that the fraud detection machine learning model is not called. For example, if the filtering model does not detect the presence of keywords indicative of fraud in the call audio or transcription and determines that the calling number is known to the called party, the model outputs an indication that the call is likely not fraudulent (e.g., the call is “filtered” out).

Responsive to the filtering model output indicating that call is likely fraudulent, the call monitoring model 222 calls a fraud detection machine learning model, which generates 514 a fraud detection value based on the filtering model output and additional input factors associated with the calling number and the content of the call. For example, in various embodiments, the fraud detection machine learning model receives as input data associated with one or more of an identity associated with the calling number, a reputation of the calling number, a relationship between the calling number and the called device, a tone of voice in audio received from the calling device, a semantic understanding of the call audio, and the presence of keywords indicative of fraud.

If the fraud detection value exceeds a threshold, the call monitoring module 222 generates and outputs 516 a fraud detection alert to the called device 120. For example, in one embodiment, the alert includes one or both of a message displayed on a graphical user interface of the called device 120, audio output from the called device 120, and haptic feedback to the called device 120, such as a vibration, ensuring that the called party is notified of the fraud detection even in the event that the user is not looking at the graphical user interface on their device. Regardless of the specific method used, notifying the called party of the likely fraud allows the user to end the call and decreases the likelihood that the calling party is successful in their attempt to defraud the called party.

### Example Computing Device

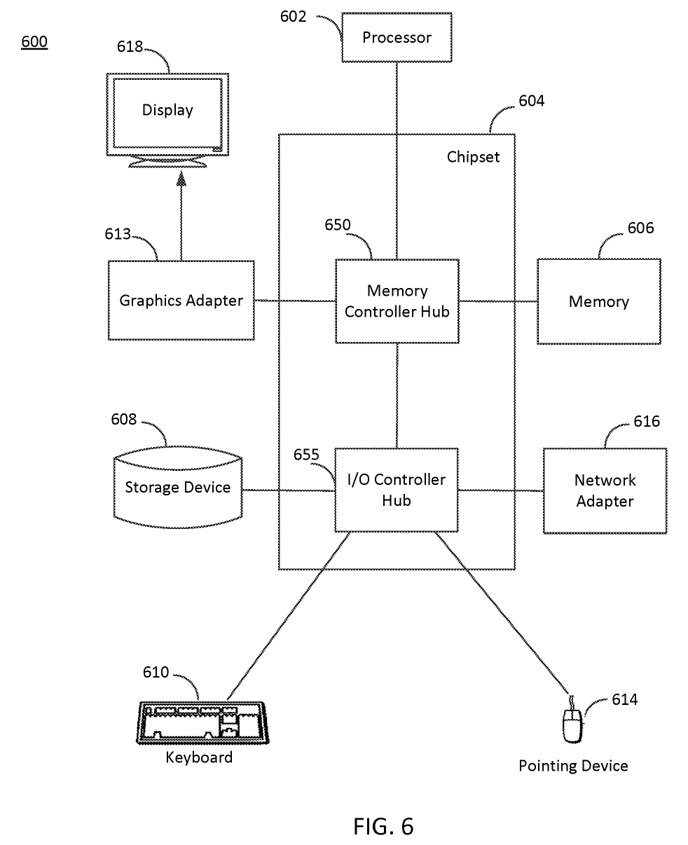

FIG. 6 is a high-level block diagram illustrating an example of a computer for use as the calling device 110, called device 120, or caller verification server 130 according to one embodiment. Illustrated are at least one processor 602 coupled to a chipset 604. The chipset 604 includes a memory controller hub 650 and an input/output (I/O) controller hub 655. A memory 606 and a graphics adapter 613 are coupled to the memory controller hub 650, and a display device 618 is coupled to the graphics adapter 613. A storage device 608, keyboard 610, pointing device 614, and network adapter 616 may be coupled to the I/O controller hub 655. Other embodiments of the computer 600 have different architectures. For example, the memory 606 is directly coupled to the processor 602 in some embodiments.

The storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is used in combination with the keyboard 610 to input data into the computer system 600. The graphics adapter 613 displays images and other information on the display device 618. In some embodiments, the display device 618 includes a touch screen capability for receiving user input and selections. The network adapter 616 couples the computer system 600 to a network, such as the telephone network 105 or the data network 115. Some embodiments of the computer 600 have different or other components than those shown in FIG. 6. For example, the caller verification server 130 can be formed of multiple blade servers and lack a display device, keyboard, and other components.

The computer 600 is adapted to execute computer program modules for providing functionality described herein. As used herein, the term “module” refers to computer program instructions and other logic used to provide the specified functionality. Thus, a module can be implemented in hardware, firmware, or software. In one embodiment, program modules formed of executable computer program instructions are stored on the storage device 608, loaded into the memory 606, and executed by the processor 602.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/- 10% unless another meaning is apparent from the context. For example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate that additional alternative structural and functional designs are possible. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

1. A computer-implemented method of performing real-time fraud detection, the method comprising:
monitoring an in-progress call from a calling device to a called device;
generating, by a filtering model, an indication of whether the call is fraudulent based on one or both of a Calling number used by the calling device and an analysis of audio of the in-progress call;
responsive to the filtering model outputting an indication that the call is fraudulent, providing, to a fraud detection machine learning model, data associated with the calling number and content of the call;
generating, by the fraud detection machine learning model based on the provided data, a fraud detection value indicating a likelihood that the call is fraudulent; and
responsive to the fraud detection value exceeding a threshold, causing a fraud detection alert to be generated by the called device.

2. The computer-implemented method of claim 1, wherein the data associated with the calling device indicates one or more of a calling number used by the calling device, a reputation value of the calling number, or a relationship between the calling number and the called device.

3. The computer-implemented method of claim 1, wherein the data associated with the content of the call indicates one or more of a semantic understanding of the call audio, a presence of keywords indicative of fraud, or a tone of voice of audio sent by the calling device.

4. The computer-implemented method of claim 1, wherein generating the indication of whether the call is fraudulent comprises applying a lookup operation to determine whether a calling number matches an entry in a block list or spam caller database.

5. The computer-implemented method of claim 1, wherein generating the indication of whether the call is fraudulent comprises detecting a keyword in the audio of the in-progress call or a transcript generated from the audio of the in-progress call.

6. The computer-implemented method of claim 1, wherein the filtering model applies relationship context rules that lower a fraud likelihood when the calling number appears in a contact list of the called device.

7. The computer-implemented method of claim 1, wherein generating the fraud detection value comprises combining outputs from multiple detection layers including two or more of:
a keyword or phrase matching layer;
a semantic pattern analysis layer;
a tone marker evaluation layer; or
an AI voice likelihood modeling layer.

8. The computer-implemented method of claim 7, wherein the semantic pattern analysis layer applies a large language model trained to detect intent and abnormal dialogue structures.

9. The computer-implemented method of claim 7, wherein the tone marker evaluation layer identifies tones of voice indicative of potential fraud based on one or more of: measuring urgency cues, irregular pitch changes, abnormal pacing, pauses, or vocal stress markers.

10. The computer-implemented method of claim 1, further comprising performing real-time AI-generated voice detection on the call audio to generate an AI-voice likelihood value, wherein the fraud detection value is further based on the AI-voice likelihood value.

11. The computer-implemented method of claim 1, wherein the fraud detection alert causes a notification to be presented on the called device, the notification including at least one of:
a visual banner;
an audio tone or message; or
haptic feedback.

12. The computer-implemented method of claim 1, wherein monitoring the in-progress call further comprises generating a text transcription via automatic speech recognition, and wherein generating the indication of whether the call is fraudulent comprises analyzing the transcription for semantic inconsistencies or suspicious conversational flow.

13. The computer-implemented method of claim 1, wherein the fraud detection value exceeding a second threshold triggers an adaptive screening protocol to increase sensitivity and depth of monitoring, the sensitivity being increased by at least one of: lowering a keyword detection threshold, broadening a monitored lexicon, or extending analysis duration.

14. The computer-implemented method of claim 1, further comprising invoking an AI assistant to autonomously or semi-autonomously answer and screen the in-progress call on behalf of a user of the called device, wherein the AI assistant queries the calling device to determine a nature and legitimacy of the in-progress call.

15. The computer-implemented method of claim 14, wherein the AI assistant applies configurable screening parameters automatically generated based on call context or manually provided by the user of the called device, the parameters instructing the assistant to perform one or more of:
asking a clarifying question;
requesting specific details; or
verifying accuracy of caller-provided information.

16. The computer-implemented method of claim 14, wherein the AI assistant is interruptible and presents to the user of the called device a real-time transcript or audio feed of the in-progress screening, enabling direct user takeover of the call.

17. The computer-implemented method of claim 14, wherein, responsive to the user of the called device declining to join the call, the AI assistant prompts the calling device to leave a message and generates a summary of the message using a machine learning model.

18. The computer-implemented method of claim 14, wherein the AI assistant adapts its dialogue and decision-making during screening based on the fraud detection value.

19. A non-transitory computer-readable medium comprising stored instructions for performing real-time fraud detection, the instructions, when executed, causing a computing system to perform operations including:
monitoring an in-progress call from a calling device to a called device;
generating, by a filtering model, an indication of whether the call is fraudulent based on one or both of a Calling number used by the calling device and an analysis of audio of the in-progress call;
responsive to the filtering model outputting an indication that the call is fraudulent, providing, to a fraud detection machine learning model, data associated with the calling number and content of the call;
generating, by the fraud detection machine learning model based on the provided data, a fraud detection value indicating a likelihood that the call is fraudulent; and
responsive to the fraud detection value exceeding a threshold, causing a fraud detection alert to be generated by the called device.

20. A computing system configured for performing real-time fraud detection, the computing system comprising:
one or more processors; and
one or more memories storing instructions that, when executed by the one or more processors, cause the computing system to perform operations including:
monitoring an in-progress call from a calling device to a called device;
generating, by a filtering model, an indication of whether the call is fraudulent based on one or both of a Calling number used by the calling device and an analysis of audio of the in-progress call;
responsive to the filtering model outputting an indication that the call is fraudulent, providing, to a fraud detection machine learning model, data associated with the calling number and content of the call;
generating, by the fraud detection machine learning model based on the provided data, a fraud detection value indicating a likelihood that the call is fraudulent; and
responsive to the fraud detection value exceeding a threshold, causing a fraud detection alert to be generated by the called device.
